(19) United States
(12) Patent Application Publication
(10) Pub. No.: US 2008/0235563 A1
(43) Pub. Date: Sep. 25, 2008

(54) Document displaying apparatus, document displaying method, and computer program product

(75) Inventor: Satoshi Nakamura, Chiba (JP)

Correspondence Address: HARNESS, DICKEY & PIERCE, P.L.C., P.O. BOX 8910, RESTON, VA, 20195, US

(73) Assignee: RICHO COMPANY, LIMITED

(21) Appl. No.: 12/073,749

(22) Filed: Mar. 10, 2008

(30) Foreign Application Priority Data
Mar. 19, 2007 (JP) 2007-070719

(51) Int. Cl. G06F 17/00

(52) U.S. Cl. 715/200

(57) ABSTRACT

A document displaying apparatus includes a document acquiring unit that acquires a structured document containing a plurality of structured document elements, a display-size acquiring unit that acquires a display size of a display area where the structured document is to be displayed, a sectionalizing unit that sectionalizes the structured document into pages based on the display size and an amount of the document elements, an information arranging unit that arranges the pages in the display area, and a document displaying unit that displays the pages in switchable manner.

### CROSS-REFERENCE TO RELATED APPLICATIONS

The present application claims priority to and incorporates by reference the entire contents of Japanese priority document 2007-070719 filed in Japan Mar. 19, 2007.

### BACKGROUND OF THE INVENTION

1. Field of the Invention

The present invention relates to a document displaying apparatus, a document displaying method, and a computer program product.

2. Description of the Related Art

An electronic document such as a portable document format (PDF) is generally formed in a standard page size such as A4 size. When such an electronic document is displayed on a display monitor, an entire page of the electronic document may not be displayed on a screen depending on a type and a window size of the display monitor. If the entire page is not displayed on the screen, the page needs to be scrolled in the vertical or horizontal direction to view whole the document. A page size of an electronic document can be changed by using applications such as rich-text editors and word processors; however, the size cannot always be adapted to a user's display environment because selectable sizes are limited in such applications.

On web pages, texts can automatically be wrapped along the width of a browser window by using a function of a browser to eliminate scrolling in the horizontal direction. However, because web pages are further stretched in the vertical direction, it is problematic that a scrolling amount increases in the vertical direction, increasing an amount of operations. Moreover, it is not always easy to access a desired page by scrolling, so that it becomes less convenient when referring to documents containing a large amount of information.

Japanese Patent Application Laid-Open No. 07-121344 discloses a conventional technology to eliminate necessity of changing a window size when browsing an entire document. Specifically, a size of a display window can be automatically changed in accordance with a page size of a document. Furthermore, a technology for displaying a document suitable for a client environment is disclosed in Japanese Patent No. 3543642. Specifically, in a client-server environment, information corresponding to the client environment is transferred from a server to display a document in a manner corresponding to the client environment.

For a document image that is a document recorded as an image, a technology for dividing the document image into words and morphemes for each document element to rearrange the document elements in accordance with display areas is disclosed in the following document: Henry S. Baird, “Digital Libraries & Document Image Analysis”, [online], Aug. 4, 2003, icdar2003, [searched on Feb. 2, 2007], Internet <URL>: http://www.essex.ac.uk/ese/icdar2003/keynote_presentations/BairdKeynote.pdf (p. 21-24)).

However, user's display environment is not considered in the technology disclosed in the Japanese Patent Application Laid-Open No. 07-121344. Therefore, when a window size is changed, a page size may not be fitted in the window size, requiring scrolling of the page. With the technology disclosed in the Japanese Patent No. 3543642, a server may not always retain information corresponding to a client display environment, and a client cannot freely change a size. For example, when using a vertical writing monitor to refer to a document generated for a horizontal writing monitor, because a page frame is fixed, characters may be collapsed when a scale factor is changed to display the entire document on the monitor or the entire document may not be displayed on one screen when trying to display the document with a readable character size.

Although divided document elements can be arranged in accordance with display areas in the technology disclosed in the document of Henry S. Baird, “Digital Libraries & Document Image Analysis”, [online], Aug. 4, 2003, icdar2003, [searched on Feb. 2, 2007], Internet <URL>: http://www.essex.ac.uk/ese/icdar2003/keynote_presentations/BairdKeynote.pdf (p. 21-24), the entire document page may not be displayed at one time when the contents of the document is large because the document elements are merely arranged in order along with the contents of the document. Therefore, scrolling in the vertical direction is necessary for referring to whole the document.

### SUMMARY OF THE INVENTION

It is an object of the present invention to at least partially solve the problems in the conventional technology.

According to an aspect, of the present invention, there is provided a document displaying apparatus that includes a document acquiring unit that acquires a structured document containing a plurality of structured document elements; a display-size acquiring unit that acquires a display size of a display area where the structured document is to be displayed; a sectionalizing unit that sectionalizes the structured document into pages based on the display size and an amount of each of the document elements; an information arranging unit that arranges the pages in the display area; and a document displaying unit that displays the pages in switchable manner.

According to another aspect of the present invention, there is provided a document displaying method that includes acquiring a structured document containing a plurality of structured document elements; acquiring a display size of a display area where the structured document is to be displayed; sectionalizing the structured document into pages based on the display size and an amount of each of the document elements; arranging the pages in the display area; and displaying the pages in switchable manner.

According to still another aspect of the present invention, there is provided a computer program product that stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram of a document displaying apparatus according to a first embodiment of the present invention;

FIG. 2 is a flowchart of a document structuring process performed by a document element structuring unit shown in FIG. 1;

FIG. 3 is an example of a structured document according to the first embodiment;

FIG. 4 is a flowchart of the document structuring process shown in FIG. 2;

FIG. 5 is an example of a structured document;

FIG. 6 is a flowchart of a document displaying process performed by the document displaying apparatus shown in FIG. 1;

FIGS. 7A to 7C are examples of a display processed in the document displaying process shown in FIG. 6;

FIG. 8 is a functional block diagram of a document displaying apparatus according to a second embodiment of the present invention;

FIG. 9 is a flowchart of a bookmark registering process performed by a bookmark registering unit shown in FIG. 8;

FIG. 10 is a flowchart of a bookmark displaying process performed by a bookmark displaying unit shown in FIG. 8;

FIG. 11 is a flowchart of a bookmark selecting process performed by a bookmark selecting unit shown in FIG. 8;

FIG. 12 is an example of a display of a document displayed by a document displaying apparatus shown in FIG. 8;

FIG. 13 is a functional block diagram of a document displaying apparatus according to a third embodiment of the present invention;

FIG. 14 is a flowchart of a document searching process performed by the document displaying apparatus shown in FIG. 13;

FIG. 15 is an example of a display of a document displayed by the document displaying apparatus shown in FIG. 13; and

FIG. 16 is a block diagram of a hardware configuration of the document displaying apparatuses shown in FIGS. 1, 8, and 13.

### DETAILED DESCRIPTION OF THE PREFERRED EMBODIMENTS

Exemplary embodiments of the present invention are described in detail with reference to the accompanying drawings. Although the present invention is applied to a document displaying apparatus in the following embodiments, the present invention is also applicable to personal computers (PCs) and information equipments including a display device, such as portable equipments.

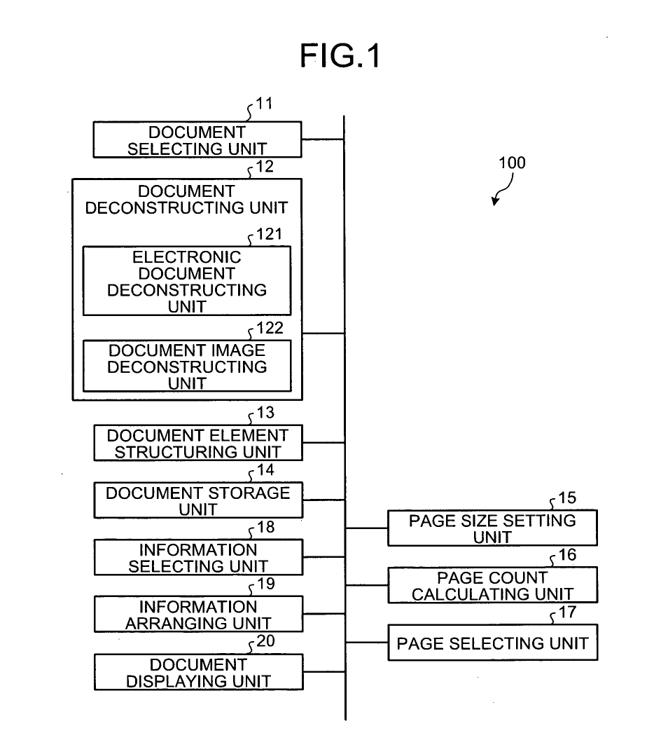

FIG. 1 is a functional block diagram of a document displaying apparatus 100 according to a first embodiment of the present invention. The document displaying apparatus 100 includes a document selecting unit 11, a document deconstructing unit 12, a document element structuring unit 13, a document storage unit 14, a page size setting unit 15, a page count calculating unit 16, a page selecting unit 17, an information selecting unit 18, an information arranging unit 19, and a document displaying unit 20.

The document selecting unit 11 receives an instruction signal indicative of selection of a document desired to be displayed from a user through an input device 6, etc. A document to be displayed can be a document stored in the document storage unit 14 or a document stored in a storage device (not shown). A document is a concept including an electronic document represented by character codes and a document image having an entire document represented by an image. The document may include pictures, graphics, tables, etc., in the main body.

The document deconstructing unit 12 includes an electronic document deconstructing unit 121 and a document image deconstructing unit 122, and acquires a document selected by the document selecting unit 11 from the document storage unit 14 and the like, and analyzes a data structure (layout) of an acquired document. The document deconstructing unit 12 deconstructs the selected document into document elements if it is determined that the document is not deconstructed and structured, i.e., if it is determined that the document is not a document stored in the document storage unit 14 (a structured document). The document elements represent elements that make up one document. Examples of the document elements include mean morphemes, words, images, and tables.

If the selected document is an electronic document, the electronic document deconstructing unit 121 deconstructs the electronic document into the document elements such as a character string portion, an image, and a table by using a known technology such as a morpheme analysis.

If the selected document is a document image, the document image deconstructing unit 122 deconstructs the document image into the document element based on the intervals and layout of images making up the document image. If character images included in the document image have an interval equal to or smaller than a predetermined value, the document image deconstructing unit 122 determines that the character images form a character string portion making up the same word, and deconstructs the character string portion on the basis of a word.

It is possible to manage a document on the basis of a word by a method other than the method described above. For example, a document image can be handled in the same manner as the above electronic document by using a known character recognition technology such as OCR (Optical Character Recognition) to recognize characters shown on the document image and handle the document image as an electronic document.

The document element structuring unit 13 determines attributes of the document elements included in the document based on the document elements deconstructed by the document deconstructing unit 12, and generates a structured document having the document elements structured based on the determined attributes. The attributes of the document elements include attributes of the document elements itself such as the character portions, images, and tables, and attributes related to contents described in the character string portions (e.g., title, sub-title). The structuring of the document elements performed by the document element structuring unit 13 will be described later.

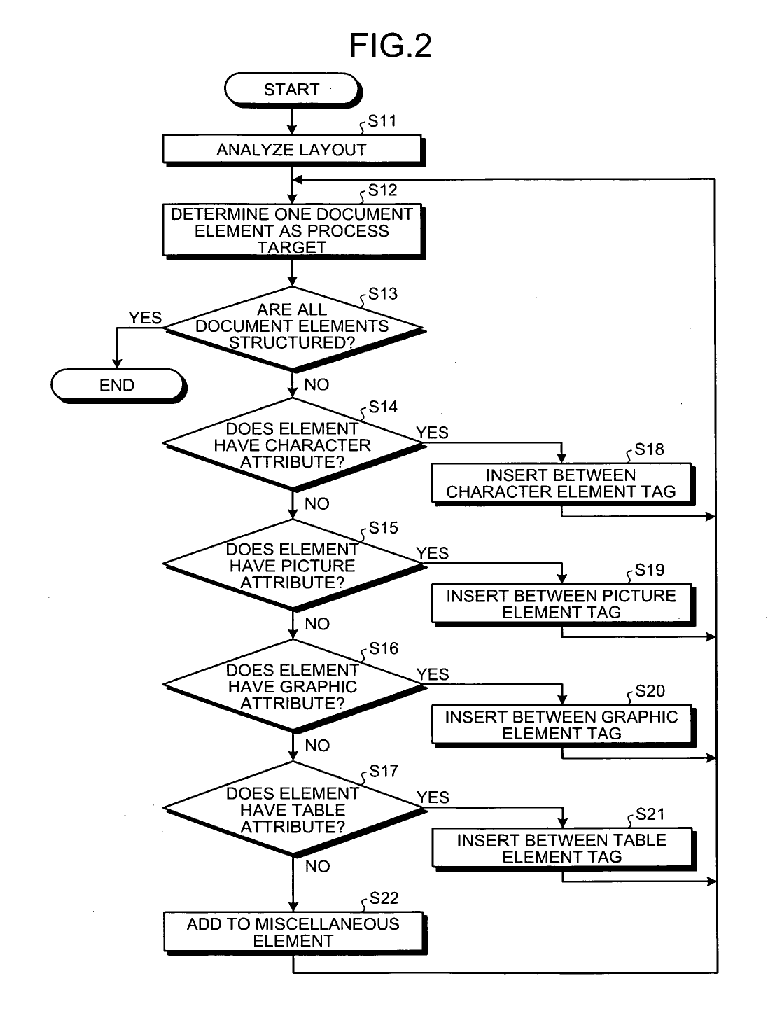

FIG. 2 is a flowchart of a first document structuring process executed by the document element structuring unit 13. The document element structuring unit 13 analyzes the layout of the document selected through the document selecting unit 11 (step S11), and determines one document element deconstructed by the document deconstructing unit 12 as a process target (step S12).

The document element structuring unit 13 then determines whether all the document elements are processed. If it is determined that an unprocessed document element exists (No at step S13), the document element structuring unit 13 determines an attribute for the document element determined as the process target (steps S14 to S17). If it is determined that the document element to be processed has a character attribute representing a character string (Yes at step S14), the document element structuring unit 13 records the document element on a structured document, which will be described later, as an element belonging to a structured element with an element name “character” (step S18). Then, process control goes back to step S12 to determine the next document element as a process target. A structured element serves as a constitutional unit of a structured document and retains the document elements in association with the attributes.

If it is determined that the document element to be processed has a picture attribute representing a picture (No at step S14 and Yes at step S15), the document element structuring unit 13 records the document element on the structured document as an element belonging to a structured element with an element name “picture” (step S19). Then, process control goes back to step S12 to determine the next document element as a process target.

If it is determined that the document element to be processed has a graphic attribute representing a graphic (No at step S14, No at step S15′, and Yes at step S16), the document element structuring unit 13 records the document element on the structured document as an element belonging to a structured-element with an element name “graphic” (step S20). Then, process control goes back to step S12 to determine the next document element as a process target.

If it is determined that the document element to be processed has a table attribute representing a table (No at step S14, No at step S15, No at step S16, and Yes at step S17), the document element structuring unit 13 records the document element on the structured document as an element belonging to a structured element with an element name “table” (step S21). Then, process control goes back to step S12 to determine the next document element as a process' target.

If it is determined that the document element to be processed does not correspond to any of the attributes described above (No at step S14, No at step S15, No at step S16, and No at step S17), the document element structuring unit 13 records the document element on the structured document as an element belonging to a structured element of “miscellaneous” (step S22). Then, process control goes back to step S12 to determine the next document element as a process target.

On the other hand, if it is determined at step S13 that all the document elements are processed (Yes, at step S13), process control is terminated.

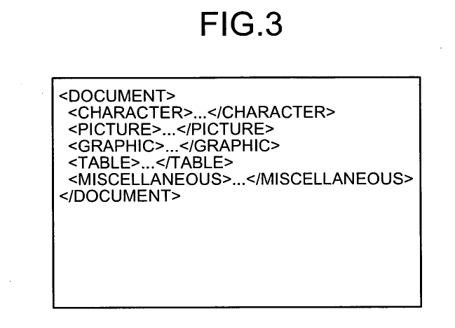

FIG. 3 is an example of a structured document generated by the document structuring process shown in FIG. 2. The attributes of the document elements determined in the document structuring process are recorded in a structured state of the extensible markup language (XML) format. In the XML, a start tag and an end tag are used to represent a structure.

The start tag is an element name enclosed in symbols “<” and “>”, and the end tag is the same element name as that of the start tag enclosed in symbols “</” and “>” These tags mean that the contents of the document elements sandwiched by the start and the end tags belong to the element name of the start tag. In the structured document, the order of appearance of the document elements corresponds to the order of appearance in the original document. Among tags of the element name “document”, data enclosed in a series of the start and end tags (e.g., between <character> and </character>) correspond to one structured element.

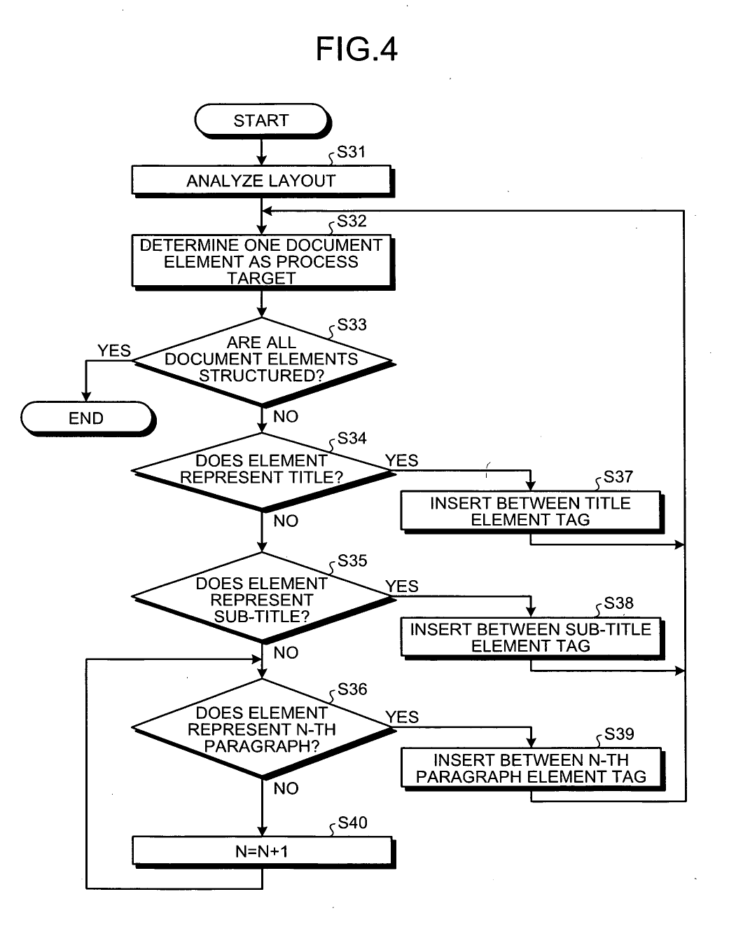

Attributes are determined based on the file characteristics of the document elements in the document structuring process described in connection with FIG. 2. However, the attributes can be determined based on the contents of the document elements (character strings) as described in connection with FIG. 4.

FIG. 4 is a flowchart of a second document structuring process executed by the document element structuring unit 13. It is assumed that the document element to be processed is a character string regardless of whether an electronic document or a document image.

The document element structuring unit 13 analyzes the layout of the document selected through the document selecting unit 11 (step S31), and determines one document element deconstructed by the document deconstructing unit 12 as a process target (step S32).

The document element structuring unit 13 then determines whether all the document elements are processed (step S33). If it is determined that an unprocessed document element exists (No at step S33), the document element structuring unit 13 determines an attribute for the document element determined as the process target (steps S34 to S36).

If it is determined that the document element (character string portion) to be processed represents the title of the document (Yes at step S34), the document element structuring unit 13 records the document element on a structured document, which will be described later, as an element belonging to a structure with an element name “title” (step S37). Then, process control goes back to step S32 to determine the next document element as a process target. Whether the document element represents the title is determined based on a font size, a layout position, text contents, etc., of the character string portion.

If it is determined that the document element (character string portion) to be processed represents the sub-title of the document (No at step S34 and Yes at step S35), the document element structuring unit 13 records the document element on the structured document as an element belonging to a structure with an element name “sub-title” (step S38). Then, process control goes back to step S32 to determine the next document element as a process target. Whether the document element represents the sub-title is also determined based on a font size, a layout position, text contents, etc., of the character string portion as is the case with the title.

If it is determined that the document element (character string portion) to be processed represents an Nth (N is a natural number) paragraph (chapter, section) of the document (No at step S34, No at step S35, and Yes at step S36), the document element structuring unit 13 records the document element on the structured document as an element belonging to a structure with an element name “section id=“N”” (step S39). Then, process control goes back to step S32 to determine the next document element as a process target. It is assumed that N is a natural number and is automatically incremented each time the document element structuring unit 13 determines a new paragraph. Whether the document element represents the paragraph is also determined based on a font size, a layout position, text contents, etc., of the character string portion as is the case with the title.

If it is determined at step S36 that the element does not belong to the Nth paragraph, the document element structuring unit 13 increments N by one (step S40), and process control goes to step S36.

On the other hand, if it is determined at step S33 that all the document elements are processed (Yes at step S33), process control is terminated.

The first and the second document structuring processes can be executed in combination. In this case, it is preferable to perform the attribute determination of the first document structuring process (steps S14 to S17) for the document elements determined as those included in the same paragraph at step S36 of the second document structuring process.

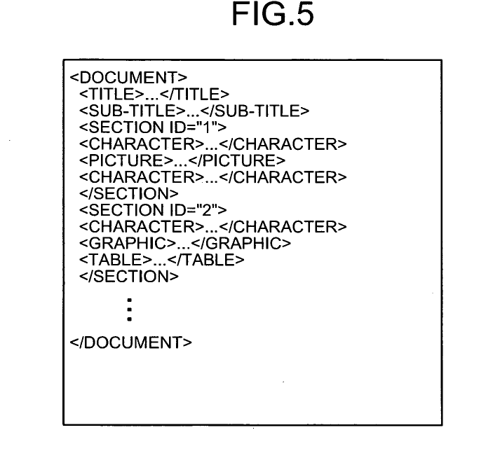

FIG. 5 is an example of a structured document generated when the first and the second document structuring processes are executed in combination. The attributes of the document elements are recorded in a structured state using the XML format. For example, an element name “section id=“1”” means that a first paragraph includes attributes listed below that element name, that is, the document elements of the character attribute, the picture attribute, and the character attribute are included in the first paragraph. Similarly, an element name “section id=“2”” means that a second paragraph includes attributes listed below that element name. Specifically, the document elements of the character attribute, the graphic attribute, and the table attribute are included in the second paragraph. In the structured document, the order of appearance of the document elements corresponds to the order of appearance in the original document.

Referring back to FIG. 1, the document storage unit 14 is a storage unit, such as a hard disk drive (HDD) 4, and stores therein documents structured by the document element structuring unit 13 (structured documents).

The page size setting unit 15 receives from a user through the input device 6 an instruction signal for setting (changing) a size of a display area such as a window displayed on a display device 5.

The page count calculating unit 16 sectionalizes the document (structured document) specified by the document selecting unit 11 into a page unit (page document) corresponding to the display area size based on the display area size received by the page size setting unit 15 and the information amounts of the structured elements included in the structured document, and then calculates the total number of pages. The information amount of the structured elements means a data size, the number of characters, a display size, etc., of the document element included in the structured element.

The page selecting unit 17′ receives through the input device 6 an instruction signal for selecting a certain page among the total number of pages calculated by the page count calculating unit 16.

The information selecting unit 18 identifies a page corresponding to the page number selected through the page selecting unit 17 among the pages sectionalized by the page count calculating unit 16.

The information arranging unit 19 sequentially arranges the document elements included in the page identified by the information selecting unit 18 based on the structured element, and generates a display page.

The document displaying unit 20 displays the display page generated by the information arranging unit 19 in the display area of the display device 5.

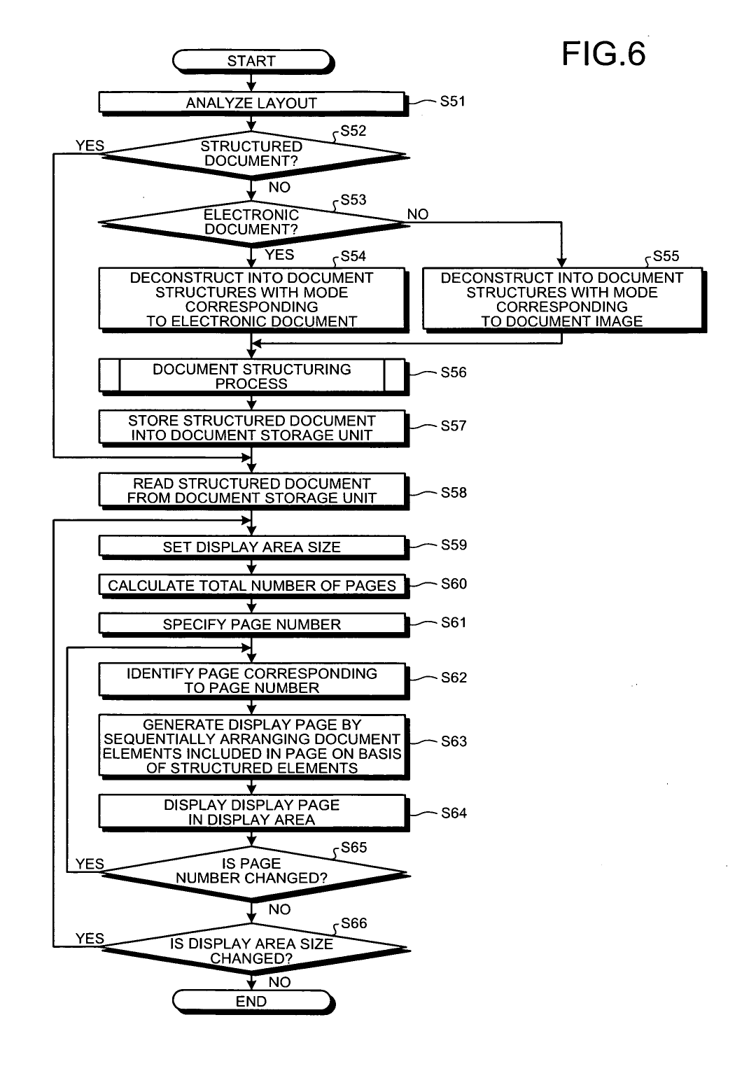

FIG. 6 is a flowchart of a document displaying process executed by the document displaying apparatus 100.

A document desired to be displayed is selected through the document selecting unit 11 by a user. When an instruction signal indicating the document is input from the document selecting unit 11, the document deconstructing unit 12 acquires a selected document from the document storage unit 14, analyzes a data structure (layout) of an acquired document (step S51), and determines whether the document is structured (step S52). If it is determined that the selected document is structured (Yes at step S52), process control immediately goes to step S58.

On the other hand, if it is determined that the document is not structured (No at step S52), the document deconstructing unit 12 determines whether the document is an electronic document or a document image (step S53).

If it is determined that the selected document is an electronic document (Yes at step S53), the document deconstructing unit 12 deconstructs the character string portions, images, etc., included in the electronic document into the document element in accordance with a mode corresponding to the electronic document (step S54). Then, process control goes to step S56.

If it is determined that the selected document is a document image (No at step S53), the document deconstructing unit 12 deconstructs the character string portions, images, etc., included in the document image into the document element in accordance with a mode corresponding to the document image (step S55). Then, process control goes to step S56.

At step S56, the document element structuring unit 13 executes the above document structuring process to generate a structured document formed by structuring the document elements deconstructed at step S54 or S55 (step S56) and then stores the generated structured document in the document storage unit 14 (step S57).

The page size setting unit 15 reads the selected document (structured document) selected at step S51 from a storage location of the document (step S58), receives an instruction signal indicating a size of the display area, and sets the indicated size as a page size of the display area for displaying the document (step S59).

The page count calculating unit 16 sectionalizes the document (structured document) read at step S58 into a page unit corresponding to the display area size in accordance with the page size set at step S59, and calculates the total number of pages (step S60).

When the page selecting unit 17 receives an instruction signal indicating a page number among the total number of pages calculated at step S60 (step S61), the information selecting unit 18 identifies a page corresponding to the page number indicated at step S61 from the pages sectionalized at step S60 (step S62).

The information arranging unit 19 generates a display page by sequentially arranging the document elements included in the page identified at step S62 in units of the structured element to which the document elements belong (step S63). The document displaying unit 20 displays the display page generated at step S63 in the display area (step S64).

The page size setting unit 15 determines whether the page number is changed (step S65). If an instruction signal for changing the page number is received (Yes at step S65), process control goes back to step S62, and the information selecting unit 18 identifies a page corresponding to the changed page number.

If an instruction signal for changing the page number is not received (No at step S65), the page selecting unit 17 determines whether the display area size is changed (step S66). If an instruction signal for changing the size is received (Yes at step S66), process control goes back to step S59 to change the page size. If the page selecting unit 17 receives an instruction signal for terminating the process (No at step S66), process control is terminated.

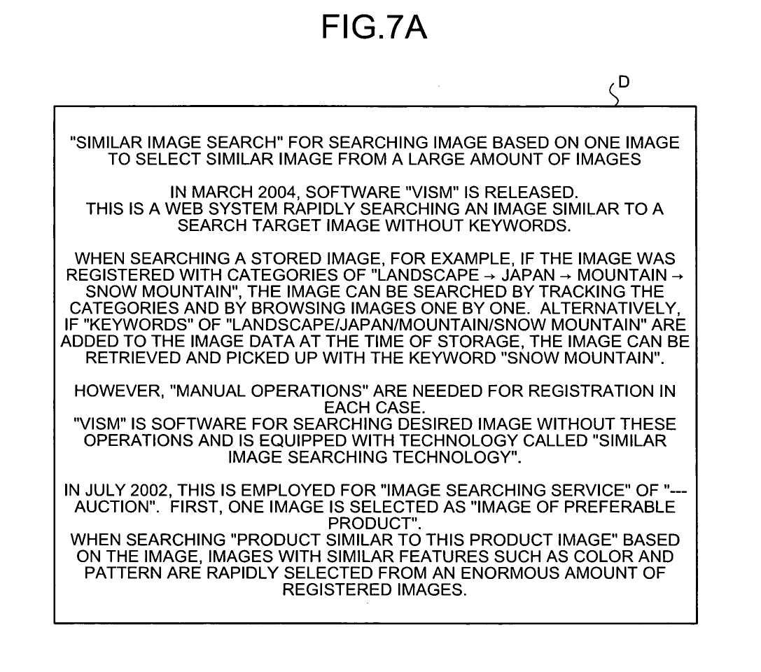

FIGS. 7A to 7C are views for explaining the above document displaying process. If a document D of FIG. 7A is selected at step S51, the document deconstructing unit 12 analyzes the data structure of the document D to determine whether the document is structured (step S52). If it is determined that the document is not structured (No at step S52), the document is structured by the operations at steps S53 to S57 depending on whether the document is an electronic document or a document image.

If the instruction signal indicating the display area size is received at step S59, the page size setting unit 15 sets the page size. As shown in FIG. 7B, a range indicated by a display area A1 corresponds to the display area size set by the page size setting unit 15.

Since the size of the display area A1 is smaller than the size of the document D that is the display target, if the display area A1 is displayed without changing the size of the document D, scroll bars must be displayed in the vertical and horizontal directions of the display area A1. Therefore, as shown in FIG. 7C, in the document displaying apparatus 100, the document elements making up the document D are rearranged based on the structured element along with the size of the display area A1 through the process at steps S60 to S64 and displayed in the display area A1.

An icon indicated by P1 of FIG. 7C is a button that inputs an instruction signal giving an instruction for moving to the next page, and when the icon is pressed, the instruction signal is output to instruct the page selecting unit 17 to change to the next page number.

As described above, according to the first embodiment, a structured document having structured document elements making up one document can be sectionalized into page documents based on a size of the display area and an information amount of each structuring block of document elements, and the document elements included in the page documents can be switched for each page document and displayed in the display area. Therefore, since the structured document having a size corresponding to the display area can be viewed only by switching the page documents without the need for scrolling in the vertical or horizontal direction, the convenience of displaying documents can be enhanced.

A document displaying apparatus according to a second embodiment is described below. The constituent elements same as the first embodiment are denoted by the same reference numerals and same explanations are not repeated.

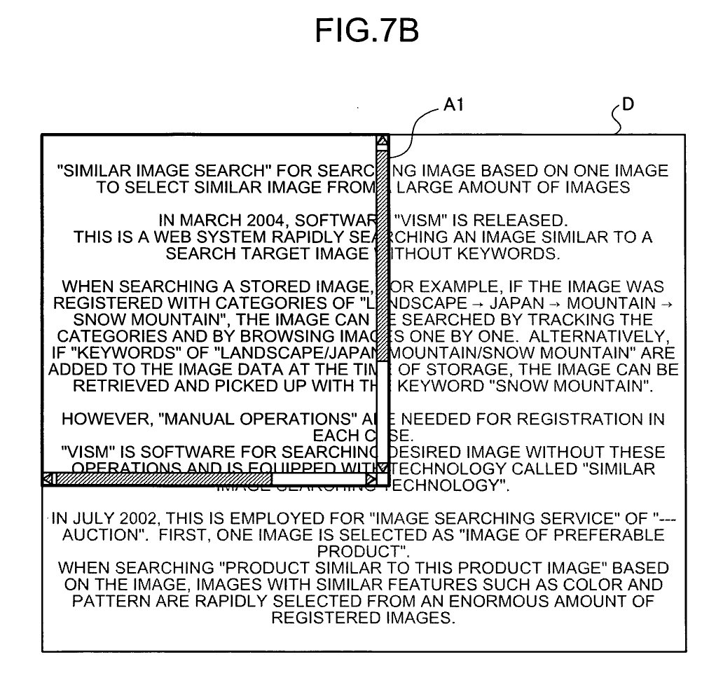

FIG. 8 is a functional block diagram of a document displaying apparatus 101 according to the second embodiment. The document displaying apparatus 101 includes a bookmark registering unit 21, a bookmark displaying unit 22, and a bookmark selecting unit 23 in addition to the constituent elements shown in FIG. 1.

The bookmark registering unit 21 registers thereon a bookmark for a page of the document displayed by the document displaying unit 20 in accordance with an instruction signal input from a user.

Specifically, the bookmark registering unit 21 stores therein marker information representing the bookmark in association with each of the structured elements of the structured document included in a displayed page. For example, tag information representing the bookmark can be added as the marker information to the structured elements of the structured document stored in the document storage unit 14.

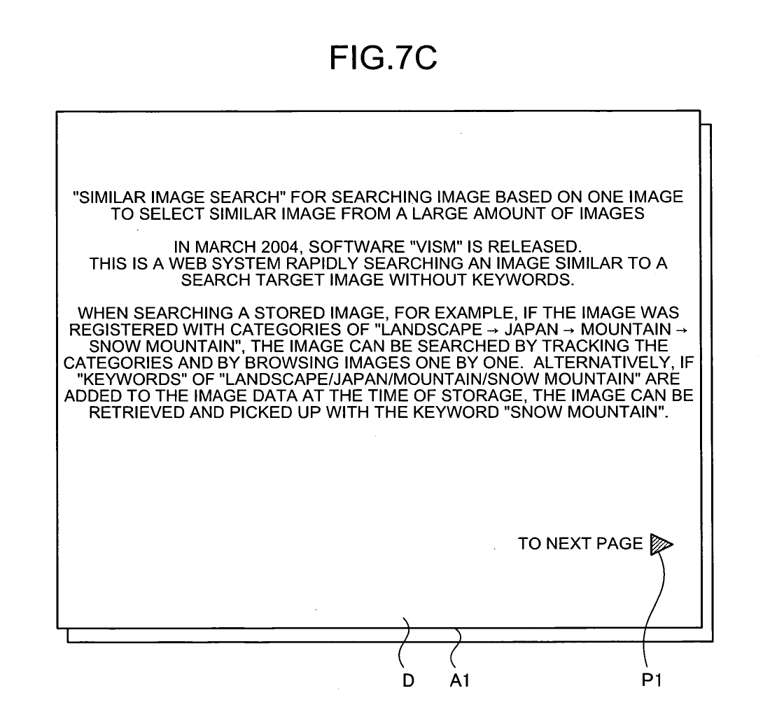

FIG. 9 is a flowchart of a bookmark registering process executed by the bookmark registering unit 21.

A page of the document selected by a user through the page selecting unit 17 is displayed by the document displaying unit 20 (step S71). When receiving instruction information for instructing bookmark registration for the displayed page (step S72), the bookmark registering unit 21 stores therein marker information in association with each of the structured elements included in the page to register a bookmark (step S73), and process control ends.

Referring back to FIG. 8, the bookmark displaying unit 22 displays the bookmark registered by the bookmark registering unit 21 within the display area in a visible manner.

Specifically, if the marker information is stored in association with the structured elements included in pages of the structured document sectionalized into pages, the bookmark displaying unit 22 determines that the bookmark is registered for the pages and displays the bookmark information such as icon images on the corresponding pages.

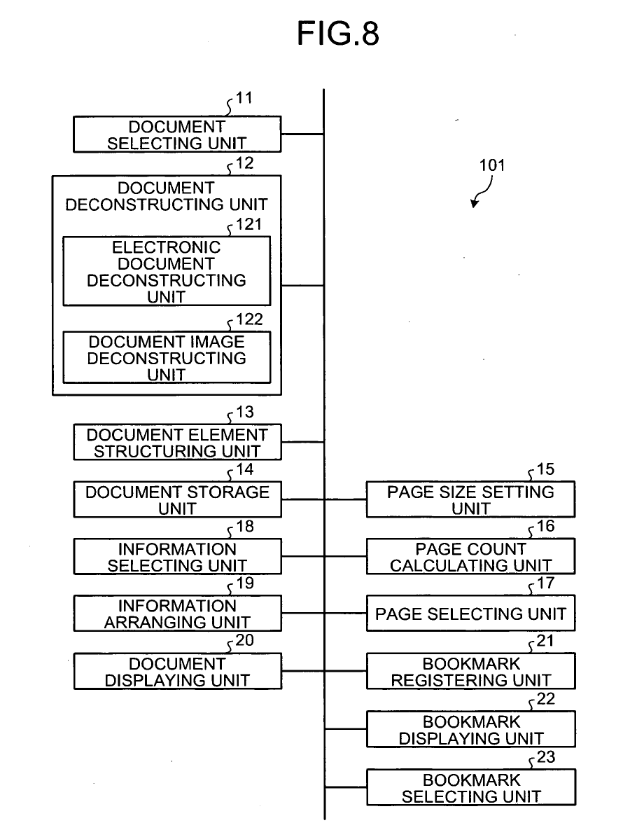

FIG. 10 is a flowchart of a bookmark displaying process executed by the bookmark displaying unit 22. The bookmark displaying process is executed concurrently with the above document displaying process.

For each page sectionalized at step S60 of FIG. 6, the bookmark displaying unit 22 refers to the structured elements included in the page (step S81), and determines whether the document element associated with the marker information is present in one page (step S82).

If it is determined that document element associated with the marker information is not present in one page (No at step S82), process control immediately goes to step S84.

On the other hand, if it is determined that the document element associated with the marker information is present in one page (Yes at step S82), the bookmark displaying unit 22 displays the bookmark information indicating that the bookmark is registered for the page (step S83), and process control goes to step S84. At step S83, a thumbnail image of a page with registered bookmark or a portion of the document structure included in the page can be acquired to display these pieces of information as the bookmark information.

It is determined whether the bookmark displaying unit 22 executes the process at steps S82 to 83 for all the pages sectionalized at step S60 (step S84). If an unprocessed page exists (No at step S84), process control goes back to step S81 to determine the next page as a process target.

If it is determined that the bookmark displaying unit 22 executes the process of steps S82 to 83 for all the pages sectionalized at step S60 (Yes at step S84), process control is terminated.

Since whether the bookmark is registered is determined in units of the structured element in the above manner, a page including the structured elements having the marker information can be indicated by the bookmark information even if the display area size (page size) is changed or the configuration of the document elements (structured elements) displayed on one page is varied.

Referring back to FIG. 8, the bookmark selecting unit 23 receives an instruction signal for selecting a piece of bookmark information from the bookmark information representing the bookmarks displayed in a visible manner. The bookmark selecting unit 23 also delivers the page number specified by the received bookmark information to the page selecting unit 17 to give an instruction for displaying the corresponding page number.

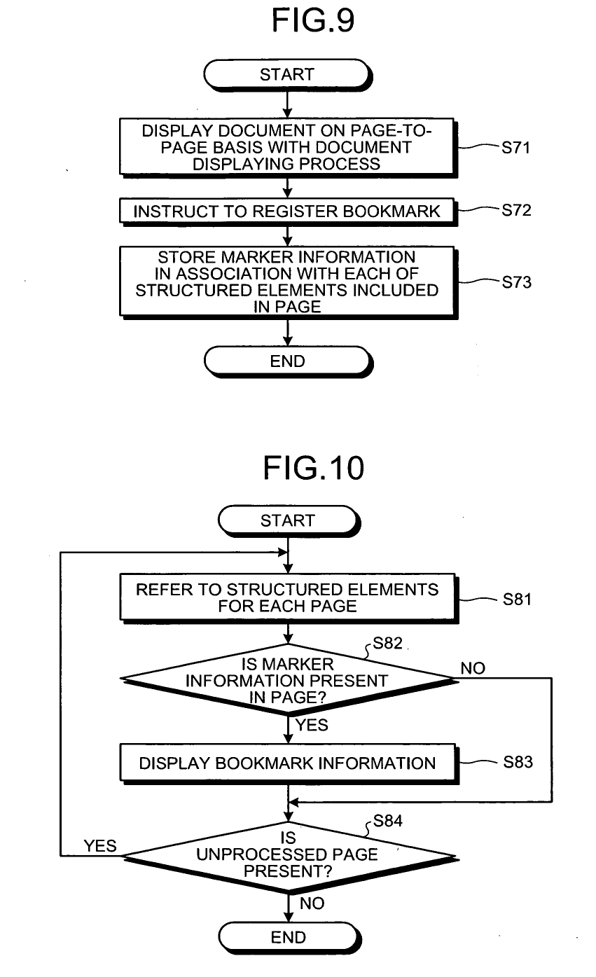

FIG. 11 is a flowchart of a bookmark selecting process executed by the bookmark selecting unit 23. It is assumed that the bookmark information is displayed to indicate that the bookmarks are registered.

When one piece of the bookmark information is selected by a user from a list of the bookmark information representing the bookmarks displayed by the bookmark displaying unit 22, the bookmark selecting unit 23 receives selected bookmark information (step S91).

The bookmark selecting unit 23 then identifies a page number corresponding to the bookmark information received at step S91 (step S92).

The information arranging unit 19 generates a display page by sequentially arranging the document elements included in the page identified at step S92 based on the structured element to which the document elements belong (step S93). The document displaying unit 20 displays the display page generated at step S93 in the display area (step S94), and then process control ends.

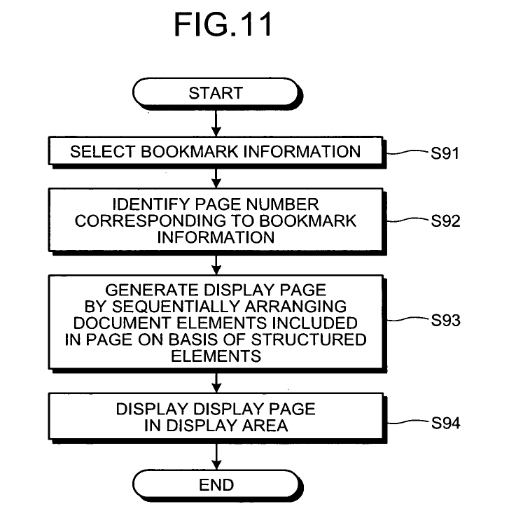

FIG. 12 is an example of display of a document displayed by the document displaying apparatus 101. A display area A2 displaying a document is disposed within a main window W1 that is a display area. In the display area A2, the pages of the document selected by a user are displayed in an open book view.

M1, M2, and M3 of the display areas A2 are bookmark information (icon images) representing bookmarks displayed by the bookmark displaying unit 22 and are associated with respective corresponding page positions.

When a user wants to register a bookmark for the currently displayed page, an instruction signal can be output to the bookmark registering unit 21 by pressing down a bookmark button B1. In the example shown in FIG. 12, apart from the bookmark information M1 to M3, information about the pages having the bookmark registered is displayed as bookmark information M11 to M13 in a display area A3.

The display area A3 displays the respective pieces of the bookmark information, which are icon images associated with thumbnail images of the pages having the registered bookmarks with portions of the document elements included in the pages. By displaying the bookmark information with the thumbnail images in this manner, a user can view overall images of corresponding pages. By displaying portions of the document elements such as titles and keywords included in the pages, a user can comprehend the contents of the pages.

It is preferable to clearly show relation between the bookmark information M11 to M13 displayed in the display area A3 and the bookmark information M1 to M3 displayed in the display area A2. For example, the same number may be displayed for the bookmark information in the display area A3 and the bookmark information in the display area A2 corresponding to the same page. Alternatively, as shown in FIG. 12, if certain bookmark information (e.g., the bookmark information M3) is selected from the bookmark information displayed in the display area A2, the color or shape can be changed in the bookmark information in the display area A3 corresponding to the relevant bookmark information.

If a user uses a bookmark to display a corresponding page, the instruction information is output to the bookmark selecting unit 23 by selecting the bookmark information displayed in the display area A2 or the display area A3, and the document of the relevant page is displayed. In the example shown in FIG. 12, a thumbnail image of the most recently displayed page and a portion of the document elements included in the page are associated with each other and displayed in a display area A4. When the thumbnail image is selected, if the instruction information indicating the page of the thumbnail image is output to the information arranging unit 19, it is easy to return to the most recently displayed page, and therefore, the user's convenience can further be improved.

In the example shown in FIG. 12, by selecting an arbitrary page position of the document displayed in a book shape view, i.e., a certain position corresponding to the fore edge, a page number corresponding to a selected page position can be output to the page selecting unit 17.

As described above, according to the second embodiment, because a plurality of pages can be easily moved from/to one another, the convenience of displaying documents can further be improved. Furthermore, the marker information is added for each of the structured element of the document elements. Therefore, even if the display area size is changed, the bookmark information can be displayed on the new page document containing a structuring block of the page document indicated by the previous bookmark information. Thus, the convenience of displaying documents can be improved.

Although the document is displayed in the open-book-shaped display in the example shown in FIG. 12, the document can be displayed on a page-to-page basis, as a plurality of arranged pages, or in another size in accordance with the display area.

A document displaying apparatus according to a third embodiment is described below. The constituent elements same as the first embodiment are denoted by the same reference numerals and the same explanations are not repeated.

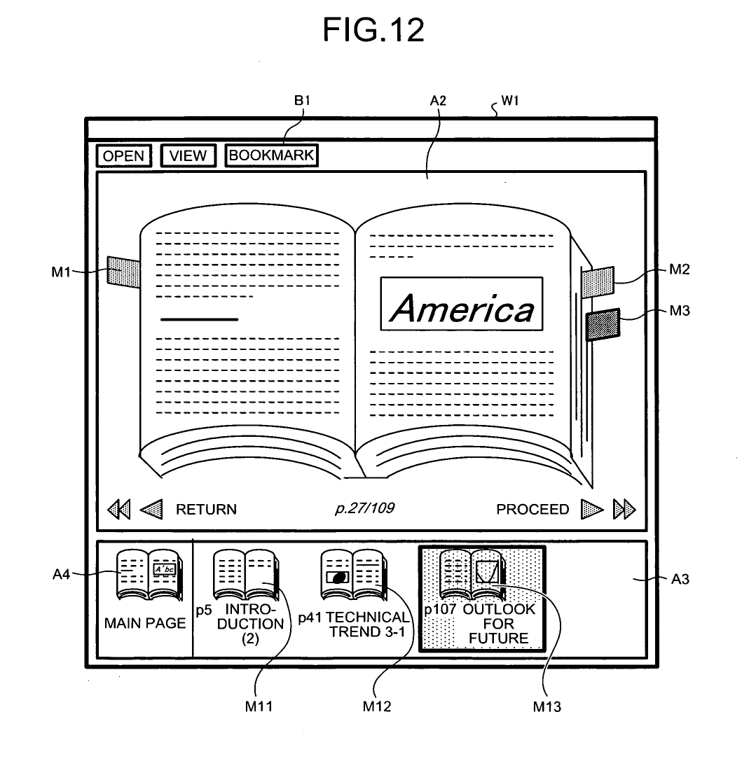

FIG. 13 is a functional block diagram of a document displaying apparatus 102 according to the third embodiment. The document displaying apparatus 102 includes a search key input unit 24, a searching unit 25, and a search result displaying unit 26 in addition to the constituent elements shown in FIG. 1.

The search key input unit 24 receives input of a search key from a user for the document displayed with the above document displaying process.

The searching unit 25 searches a character string portion corresponding to the search key received by the search key input unit 24 from the document elements included in the display target document. If the document element is a character string image, a known technology such as pattern matching or character recognition can be used and character string images of the same shapes as the characters included in the input search key may be searched as the relevant character string portion.

The search result displaying unit 26 highlights the character string portion retrieved by the searching unit 25. Specifically, if the retrieved character string portion is present in pages other than the currently displayed page, the search result displaying unit 26 highlights the pages.

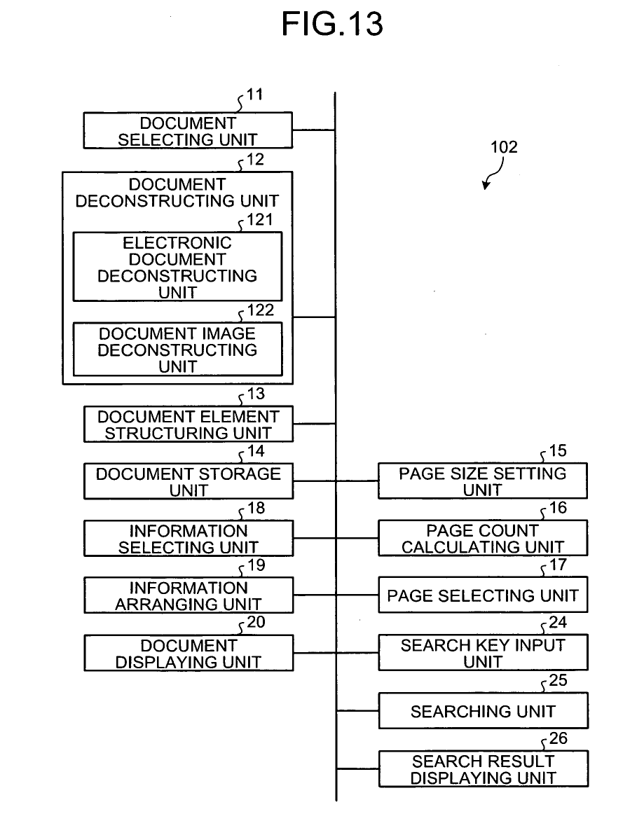

FIG. 14 is a flowchart of a document searching process executed by the document displaying apparatus 100.

When the search key input unit 24 receives (acquires) input of a search key indicating a retrieval of a certain character string for the document displayed by the above document displaying process (step S101), the searching unit 25 searches a character string portion identical to the input search key from the document elements included in the displayed document (step S102).

If the searching unit 25 determines that identical character string portion is not present (No at step S103), the search result displaying unit 26 displays information indicating that identical character string portion is not present (step S104), and process control ends.

On the other hand, if the searching unit 25 determines that the identical character string portion is present (Yes at step S103), the search result displaying unit 26 highlights the identical character string portion (step S105).

Based on the search result from the searching unit 25, the search result displaying unit 26 determines whether the identical character string portion is present in pages other than the currently displayed page (step S106). If it is determined that relevant character string portion is not present in other pages (No at step S106), process control is terminated.

On the other hand, if it is determined that the relevant character string portion is present in other pages (Yes at step S106), search result information such as an icon image is displayed on other pages including the relevant character string portion to indicate that the searched character string portion is present (step S107), and process control is terminated. At step S107; thumbnail images of other pages including the relevant character string portion or a portion of the document structures included in the pages can be acquired and displayed as the search result information.

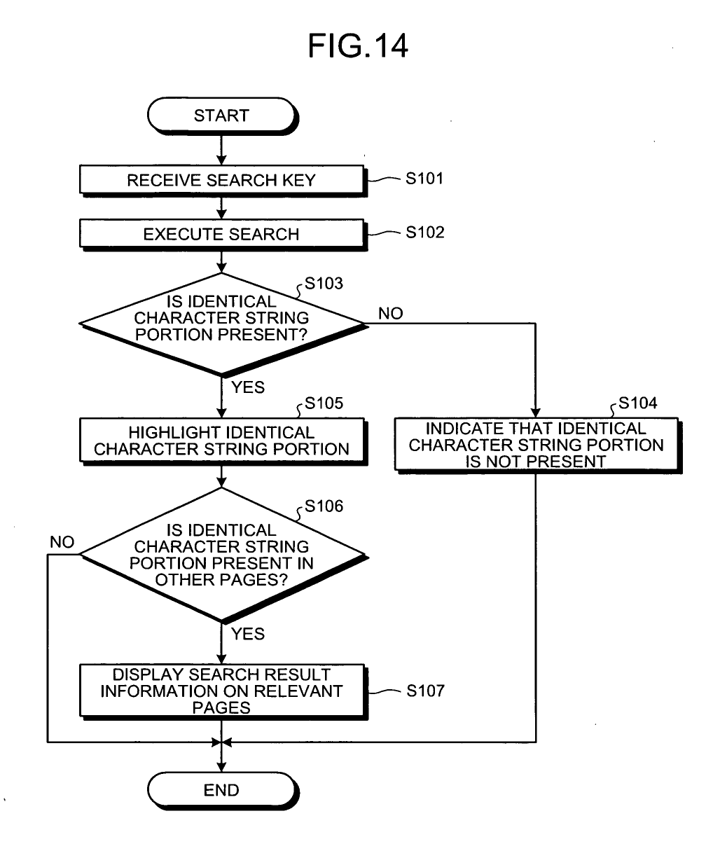

FIG. 15 is an example of a display of a document displayed by the document displaying apparatus 102. A display area A5 displaying a document is disposed within a main window W2 that is a display area. In the display area A5, the pages of the document selected by a user are displayed in an open book view.

E1, E2, and E3 of the display area A5 indicate character string portions highlighted by the search result displaying unit 26 in the displayed page. A method of highlighting includes changing a background color, changing a character color, surrounding with a frame, displaying characters in boldface, and the like.

R1, R2, and R3 of the display area A5 are search result information (icon images) displayed by the search result displaying unit 26 to indicate the pages including the search target character string portions. In the example shown in FIG. 15, apart from the search result information R1 to R3, information about pages other than the displayed page including the character string portion identical to the search key is displayed as search result information R11 to R13 in a display area A6.

The display area A6 displays pieces of the search result information, which are icon images associating thumbnail images of the pages including the character string portion identical to the search key with portions of the document elements included in the pages. By displaying the search result information with the thumbnail images in this manner, a user can view overall images of corresponding pages. By displaying portions of the document elements such as titles and keywords included in the pages, a user can comprehend the contents of the pages.

It is preferable to clearly show relation between the search result information displayed in the display area A5 and the search result information displayed in the display area A6 as is the case of the bookmark information in the display area A2 and the display area A3 of FIG. 12.

If a user uses the search result information to display a corresponding page, the instruction information indicating the selected page is output to the information selecting unit 18 by selecting the search result information displayed in the display area A5 or the display area A6, and the document of the relevant page is displayed. In the example shown in FIG. 15, the icon image displayed in the display area A4 is the same as described in connection with FIG. 12, and the same explanation is not repeated.

As described above, according to the third embodiment, since a certain character string portion included in the document can be retrieved and switching of the page including the character string portion can be simple, the convenience of displaying documents can be improved. Since the character string portion corresponding to the search key can be highlighted and a page other than the displayed page can be indicated by the search result information if the page includes the character string portion corresponding to the search key, user's convenience can further be improved.

Although the document is displayed in the open-book-shaped display form in the example shown in FIG. 15, the document can be displayed on a page-to-page basis, as a plurality of arranged pages, or in another size in accordance with the display area.

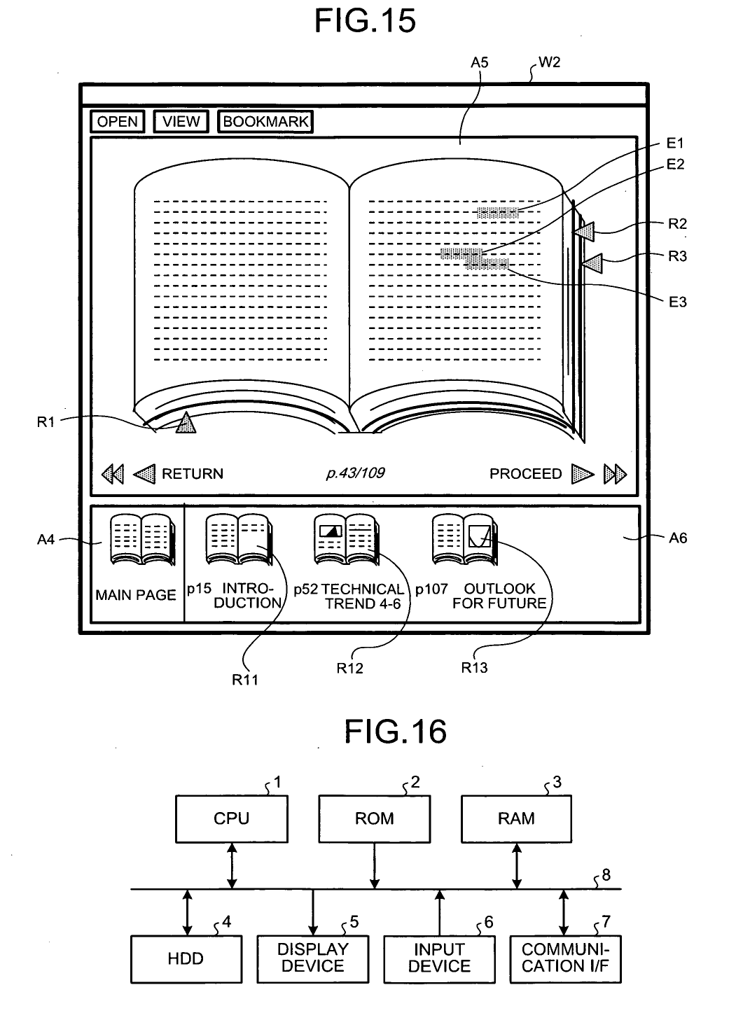

FIG. 16 is a block diagram of a hardware configuration of the document displaying apparatuses 100 to 102. The document displaying apparatuses 100 to 102 include a CPU (Central Processing Unit) 1, a ROM (Read Only Memory) 2, a RAM (Random Access Memory) 3, the HDD 4 serving as the document storage unit 14, the display device 5 such as a monitor, the input device 6 such as a keyboard and a mouse, and a communication interface (I/F) 7 as well as a bus 8 connecting the above units with a hardware configuration utilizing a standard computer.

Various computer programs executed by the document displaying apparatuses 100 to 102 are stored in files in an installable format or an executable format and provided by recording the files on a computer-readable recording medium such as compact disc (CD)-ROM, flexible disc (FD), compact disc-recordable (CD-R), and digital versatile disc (DVD).

The programs executed by the document displaying apparatuses 100 to 102 can be stored in a computer connected to a network such as the Internet and can be downloaded through the network. The computer programs executed by the document displaying apparatuses 100 to 102 can also be provided or distributed through a network such as the Internet. The computer programs of the first to the third embodiments can be built into a ROM, etc.

The computer programs executed by the document displaying apparatuses 100 to 102 have a module configuration including the above units (such as the document selecting unit 11, the document deconstructing unit 12, the document element structuring unit 13, the page size setting unit 15, the page count calculating unit 16, the page selecting unit 17, the information selecting unit 18, the information arranging unit 19, the document displaying unit 20, the bookmark registering unit 21, the bookmark displaying unit 22, the bookmark selecting unit 23, the search key input unit 24, the searching unit 25, and the search result displaying unit 26), and the above units are loaded on a main storage device by reading and executing the computer programs from the storage medium (the ROM 2 or the HDD 4) with the CPU 1 that is actual hardware to generate, on the main storage device, the document selecting unit 11, the document deconstructing unit 12, the document element structuring unit 13, the page size setting unit 15, the page count calculating unit 16, the page selecting unit 17, the information selecting unit 18, the information arranging unit 19, the document displaying unit 20, the bookmark registering unit 21, the bookmark displaying unit 22, the bookmark selecting unit 23, the search key input unit 24, the searching unit 25, the search result displaying unit 26, etc.

According to an aspect of the present invention, a structured document having structured document elements making up one document is sectionalized into page documents based on a size of a display area and an information amount of each structuring block of document elements, and the document elements included in the page documents can be switched for each page document and displayed in the display area. Therefore, the structured document can be viewed only by switching the page documents without the need for scrolling in the vertical or horizontal direction, and the structured document having a size corresponding to the display area can be referenced. Thus, the convenience of displaying documents can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A document displaying apparatus comprising:
a document acquiring unit that acquires a structured document containing a plurality of structured document elements;
a display-size acquiring unit that acquires a display size of a display area where the structured document is to be displayed;
a sectionalizing unit that sectionalizes the structured document into pages based on the display size and an amount of each of the document elements;
an information arranging unit that arranges the pages in the display area; and
a document displaying unit that displays the pages in switchable manner.

2. The document displaying apparatus according to claim 1, further comprising a page selecting unit that receives page selection information for selecting a page from pages obtained by the sectionalizing unit, wherein
the information arranging unit arranges in the display area the page indicated by the page selection information.

3. The document displaying apparatus according to claim 1, further comprising:
a registration receiving unit that receives bookmark request information for registering a position of one or more bookmark-target pages from the pages;
a bookmark registering unit that registers marker information on the bookmark-target pages; and
a bookmark selecting unit that receives bookmark selection information for selecting marker information from the marker information registered on the bookmark-target pages, wherein
the information arranging unit identifies a page corresponding to the marker information indicated by the bookmark selection information, and arranges identified page in the display area.

4. The document displaying apparatus according to claim 3, wherein the bookmark registering unit registers the marker information to the document elements contained in the bookmark-target pages.

5. The document displaying apparatus according to claim 1, further comprising:
a search key acquiring unit that acquires a character string as a search key of the structured document;
a searching unit that searches a character string portion identical to the search key from the pages contained in the structured document; and
a highlighting unit that highlights the character string portion.

6. The document displaying apparatus according to claim 5, wherein if the highlighting unit determines that the character string portion is present in a different page other than the page displayed by the document displaying unit, the highlighting unit displays search result information indicative of the different page.

7. A document displaying method comprising:
acquiring a structured document containing a plurality of structured document elements;
acquiring a display size of a display area where the structured document is to be displayed;
sectionalizing the structured document into pages based on the display size and an amount of each of the document elements;
arranging the pages in the display area; and
displaying the pages in switchable manner.

8. The document displaying method according to claim 7, further comprising selecting including receiving page selection information for selecting a page from pages obtained at the sectionalizing, wherein
the arranging includes arranging in the display area the page indicated by the page selection information.

9. The document displaying method according to claim 7, further comprising:
receiving bookmark request information for registering a position of one or more bookmark-target pages from the pages;
registering marker information on the bookmark-target pages; and
selecting including receiving bookmark selection information for selecting marker information from the marker information registered on the bookmark-target pages, wherein
the arranging includes identifying a page corresponding to the marker information indicated by the bookmark selection information, and arranging identified page in the display area.

10. The document displaying method according to claim 9, wherein the registering includes registering the marker information to the document elements contained in the bookmark-target pages.

11. The document displaying method according to claim 7, further comprising:
acquiring a character string as a search key of the structured document;
searching a character string portion identical to the search key from the pages contained in the structured document; and
highlighting the character string portion.

12. The document displaying method according to claim 11, wherein if it is determined at the highlighting that the character string portion is present in a different page other than the page displayed at the displaying, the highlighting includes displaying search result information indicative of the different page.

13. A computer program product comprising a computer usable medium having computer readable program codes embodied in the medium that, when executed, causes a computer to execute:
acquiring a structured document containing a plurality of structured document elements;
acquiring a display size of a display area where the structured document is to be displayed;
sectionalizing the structured document into pages based on the display size and an amount of each of the document elements;
arranging the pages in the display area; and
displaying the pages in switchable manner.

14. The computer program product according to claim 13, further comprising selecting including receiving page selection information for selecting a page from pages obtained at the sectionalizing, wherein
the arranging includes arranging in the display area the page indicated by the page selection information.

15. The computer program product according to claim 13, further comprising:
receiving bookmark request information for registering a position of one or more bookmark-target pages from the pages;
registering marker information on the bookmark-target pages; and
selecting including receiving bookmark selection information for selecting marker information from the marker information registered on the bookmark-target pages, wherein
the arranging includes identifying a page corresponding to the marker information indicated by the bookmark selection information, and arranging identified page in the display area.

16. The computer program product according to claim 15, wherein the registering includes registering the marker information to the document elements contained in the bookmark-target pages.

17. The computer program product according to claim 13, further comprising:
acquiring a character string as a search key of the structured document;
searching a character string portion identical to the search key from the pages contained in the structured document; and
highlighting the character string portion.

18. The computer program product according to claim 17, wherein if it is determined at the highlighting that the character string portion is present in a different page other than the page displayed at the displaying, the highlighting includes displaying search result information indicative of the different page.
